(19) United States
(12) Patent Application Publication
(10) Pub. No.: US 2022/0030836 A1
(43) Pub. Date: Feb. 3, 2022

(54) SORTING DEVICE FOR LIVE FISH

(71) Applicant: Alfred-Wegener-lnstitut, Helmholtz-Zentrum fuer Polar- und Meeresforschung, Bremerhaven (DE)

(72) Inventors: Mirko Boegner, Bremerhaven (DE); Monika Weiss, Bremerhaven (DE)

(21) Appl. No.: 17/297,474

(22) PCT Filed: Nov. 7, 2019
(86) PCT No.: PCT/DE2019/100959

§ 371 Date: May 27, 2021

(30) Foreign Application Priority Data
Nov. 29, 2018 (DE) 10 2018 130 232.0

(51) Int. Cl. A01K 63/00

(52) U.S. Cl. CPC A01K 63/006

(57) ABSTRACT

A sorting device for live fish includes: an upwardly open water tank; and a vertical grid unit connected to an inside of the water tank via a circumferential sealing element, dividing the water tank into two separate regions, the vertical grid unit having a plurality of slit openings which are delimited by horizontal and vertical webs and which are adaptable in shape and size to the fish to be sorted and are closeable. The grid unit includes at least one carrier plate and at least one adjustment plate having an identical design and arrangement of the slit openings and of the horizontal and vertical webs. The at least one carrier plate divides the water tank into the two regions and the adjustment plate is displaceably arranged on the at least one carrier plate, and depending on a position of the adjustment plate, the slit openings are covered.

### CROSS-REFERENCE TO PRIOR APPLICATIONS

This application is a U.S. National Phase application under 35 U.S.C. § 371 of International Application No. PCT/DE2019/100959, filed on Nov. 7, 2019, and claims benefit to German Patent Application No. DE 10 2018 130 232.0, filed on Nov. 29, 2018. The International Application was published in German on Jun. 4, 2020 as WO 2020/108690 under PCT Article 21(2).

### FIELD

The invention relates to a sorting device for live fish, having an upwardly open water tank and at least one vertical grid unit which is connected to the interior of the water tank by means of a circumferential sealing element and divides the water tank into two regions separated from one another and has a plurality of slit openings which are delimited by horizontal and vertical webs and which can be adapted in their shape and size to the fish to be sorted and can be closed for them.

### BACKGROUND

Fish is a valuable food that is increasingly being produced in aquaculture. Since the individuals of many fish types, however, develop at different rates and also influence one another, it is necessary to sort the live fish in order to be able to protect them from one another or also remove them. Live fish are typically sorted with stationary or mobile nets, which means a great stress load on the fish. Therefore, sorting devices are increasingly being designed which also allow voluntary and thus low-stress self-sorting of the fish.

From WO 01/28318 A1, a sorting device for live fish with a plurality of grid units is known which are arranged horizontally one above the other in an upwardly open water tank. The grid units each have a grid with passage openings, wherein the latter become smaller in the direction of the tank bottom. Each grid divides the water tank into two regions (sorting region, non-sorting region). Fish food is located on the tank bottom as bait. Depending on their size, the fish swim through the various grids with the differently sized passage openings and sort themselves voluntarily in the water tank in such a way that the largest fish are located in the upper region and the smallest fish in the lower region of the water tank. Connecting lines lead from the individual sorting levels to further water tanks, in which only fish of primarily one size are then located. U.S. Pat. No. 2,690,158 A discloses a sorting device for live fish in which the grid unit is positioned vertically into a body of water. The grid unit comprises a grid having elongated hole-like passage openings arranged in rows and columns. These are oriented vertically so that fish of different heights are separated from one another. Furthermore, the passage openings taper conically so that the fish are prevented from swimming back. DE 10 2015 011 965 A1 discloses a sorting device for live fish for voluntary self-sorting, in which the fish are encouraged by oscillating non-return valves, a plurality of which is arranged in parallel next to one another, to swim through them. Passage openings of predetermined diameter arranged in parallel thereto allow only fish up to a certain size to swim back.

The sorting device for live fish closest to the invention is known from the publication “Influence of feeding sequence, light and colour on the performance of a self-grading-system designed for tubot (Scophthalmus maximus)” by M. Bögner et al. (in Aquacultural Engineering 77 (2017) 1-8). The generic sorting device comprises an upwardly open water tank, in the interior of which a grid unit is arranged vertically (cf. FIG. 2 ibid.). The grid unit is adapted in its size to the cross-section of the water tank and surrounded in the water region by a circumferential sealing element. It divides the water tank into two separate regions with respect to the existing fish (“sorting region” and “non-sorting region”). The sealing element prevents the fish from swimming past the grid unit, and no design-related, intervening means are required for fastening the grid unit to the tank walls (cf. Chap. 2.1.2.2 ibid.). The grid unit has a plurality of slit openings which are arranged in parallel in a plurality of columns and rows so that horizontal and vertical webs are formed between the slit openings. In this case, the slit openings are formed as horizontal elongated holes so that horizontal flatfish can swim through them. The width of the slit openings can be adapted to the width of the flatfish and have a width between 7 and 18 cm, whereas the height is constantly dimensioned to 3.5 cm. The slit openings are rounded at both ends. When a grid with a selected constant width of the slit openings is introduced into the water tank, the slit openings are closed so that the fish in the water cannot swim through them. After an idle time for calming the fish, the slit openings are opened and the fish can swim through them or be held back in accordance with their size. In the publication, a grid unit having a single selected width of the slit openings is shown. Other widths are selected by exchanging the entire grid unit, resulting in considerable stress for the fish. The slit openings are closed by a cover, the removal of which likewise induces stress.

Furthermore, it is known from EP 1 212 940 A1 to sort caught fish according to their size via a device which consists of two rows of cylinders. In order to adjust the size of fish to be allowed through, the two rows are adjustable in terms of their distance from one another. However, in this case, the adjustment axis is orthogonal to the cylinder rows. US 2015/0250149 A1 discloses a grid for a water tank which is fastened to the tank walls by means of suction cups. However, this is a separating grid with a very small mesh. It is furthermore known from U.S. Pat. No. 3,204,605 A to provide a lateral rail system on the water tank and to use it to position sprinkler pipes above the water tank and displace them. It is also known in the generic field of aeration from EP 0 179 304 A1 to provide a radiator grille in which for adjusting the size of the air outlet slits, two slit opening plates of the same design are present and can be displaced in parallel to one another in their planes. However, devices of this type are not suitable for underwater use.

From US 2011/0 107 977 A1, an aquarium separation wall is known which has small openings for water circulation and large openings for the passage of feed fish, wherein the large openings can be closed with a displaceable plate by means of a sliding door mechanism. U.S. Pat. No. 6,474,265 B1 discloses an adaptable aquarium separation wall which consists of two rigid plates having openings which are invariable in their size and which are designed to be displaceable relative to one another in order to adapt their size to the tank width. From WO 03/092 369 A1, a fish sorting device is known which has displaceable slats with sorting grids, wherein the sizes of the openings of the sorting grids can be changed. A mechanism for size adjustment is not described. Also known from JP 2012/152 146 A is an aquarium separation wall which consists of two vertically displaceable plates with openings, wherein the openings correspond to one another in the open position and overlap one another in the closed position. A displaceability in the longitudinal direction of the openings is not provided.

### SUMMARY

In an embodiment, the present invention provides a sorting device for live fish, comprising: an upwardly open water tank; and a vertical grid unit connected to an inside of the water tank via a circumferential sealing element, dividing the water tank into two separate regions, the vertical grid unit having a plurality of slit openings which are delimited by horizontal and vertical webs and which are adaptable in shape and size to the fish to be sorted and are closeable, wherein the grid unit comprises at least one carrier plate and at least one adjustment plate having an identical design and arrangement of the slit openings and of the horizontal and vertical webs, wherein the at least one carrier plate divides the water tank into the two regions and the adjustment plate is displaceably arranged on the at least one carrier plate, and depending on a position of the adjustment plate, the slit openings of the at least one carrier plate are covered by the horizontal and vertical webs of the adjustment plate so as to form effective slit openings between a maximum value and a minimum value, and wherein the effective slit openings on the at least one carrier plate are completely opened at the maximum value and are closed at the minimum value to such an extent that the fish to be sorted are prevented from swimming through.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic view of the generic sorting device from the prior art,

FIG. 2 shows the grid unit according to the invention in detail,

FIG. 3 shows the slit openings in the grid unit in detail, and

FIG. 4 shows the sorting device with a guided grid unit with a plurality of compartments.

### DETAILED DESCRIPTION

In an embodiment, the present invention develops the generic sorting device described at the outset in such a way that a variable adjustment of the slit openings can be carried out as far as possible with little effort and without a stress load for the fish.

In an embodiment, the present invention provides a sorting device in which the grid unit comprises at least one carrier plate and at least one adjustment plate having an identical design and arrangement of the slit openings and of the horizontal and vertical webs, wherein said carrier plate divides the water tank into two regions and the adjustment plate is displaceably arranged on the carrier plate and depending on the position of the adjustment plate, the slit openings of the carrier plate are covered by the horizontal and vertical webs of the adjustment plate and effective slit openings between a maximum value and a minimum value are formed, wherein the effective slit openings on the carrier plate are completely opened at the maximum value and closed at the minimum value to such an extent that the fish to be sorted are prevented from swimming through them.

In the proposed invention, the slit openings in the carrier plate are covered by the slit openings in the adjustment plate by a plane-parallel displacement of the adjustment plate on the carrier plate such that effective slit openings result. The term “effective” here refers to the actual passage width through the superposed slit openings. In this case, the effective slit openings are adjusted completely without stress for the fish. The carrier plate is introduced into the water tank; the displacement of the adjustment plate then does not produce any large movement in the water. When adjusting the size of the effective slit openings, their width can be changed by a horizontal displacement of the adjustment plate and their height can be changed by a vertical displacement of the adjustment plate, wherein the uncovered slit openings on the carrier plate represent the maximum value for the width and the height of the effective slit openings. These can only be reduced by displacing the adjustment plate. In this case, the adjustable minimum value is dimensioned such that no more fish to be sorted can swim through the slit openings. The effective slit openings reached at this adjustment are therefore all to be regarded as closed. The water circulation and the swimming through of the fish not to be sorted with a size below the minimum value are not impeded thereby. Furthermore, the vertical webs of the adjustment plate allow the slit openings in the carrier plate to be covered in such a way that ancillary effective slit openings with a smaller width than the adjusted width result, wherein only the larger effective slit openings are used for sorting. The ancillary effective slit openings, in turn, act as closed for the fish that are larger.

The inventive provision of two plates displaceable on top of one another and having a respective slit arrangement enables the slit widths to be adjusted in a particularly simple manner while leaving a single grid unit in the water tank. The very complex exchange of grid units with different slit widths is completely dispensed with. As a result, not only is the work expenditure considerably reduced, but the same also applies to the stress load for the fish. The latter barely, or not at all, perceive the displacement of the adjustment plate on the carrier plate in order to change the slit width.

Although the carrier plate and the adjustment plate show an identical design of their slit openings and webs, they can, however, be arbitrary, in particular also irregular, in terms of their size and arrangement. This can be an advantage depending on the fish species to be sorted. However, it is advantageous for the production and simple application of the plates if the slit openings have the same size and are arranged regularly. In this case, it is advantageous and preferred according to a first modification of the invention if the slit openings in the carrier plate and in the adjustment plate have an elongated hole-like design parallel to the bottom of the water tank and are arranged in a plurality of rows and columns, wherein all slit openings have the same height and width.

Such a design of the slit openings is particularly suitable for sorting processes in the case of flatfish which float with their flat side parallel to the bottom. In this case, the flatfish differ in their growth stages primarily in their width or in their diameter and not in their height. It is therefore sufficient to make the width of the effective slit openings variable and to leave the height constant. Moreover, the adjustment plate only has to be arranged on the carrier plate in a horizontally displaceable manner. Vertical displaceability is dispensed with. Injuries can also be avoided if, according to a next advantageous modification, the slit openings are designed to be semi-circular at their two ends. This moreover results in a precisely defined, constant width of the slit openings, which guarantees that only fish up to a predetermined maximum width can swim through them. In the case of angular or elliptically rounded slit openings, different widths result in the diagonals, which widths can falsify the sorting result. Furthermore, it is advantageous to offer as many slit openings as possible to the fish in order to produce as little additional stress as possible. A further development of the sorting device according to the invention is therefore preferred and advantageous if the horizontal webs are as narrow as structurally possible and the vertical webs are designed to be wider than the horizontal webs. This results in a large number of slit openings in individual columns and a large effective passage area. In contrast, the vertical webs are of wider design, for example five to six times as wide as the horizontal webs, and serve to change the width of the effective slit openings in the event of an exclusively horizontal displacement of the adjustment plate on the carrier plate.

The slit openings in the invention may have any geometric shapes. They can, in particular, be round or square but also rectangular or oval, in each case in a regular or else in an irregular shape. By superposing the adjustment plate with the carrier plate having an identical design and distribution of the slit openings in each case, virtually any desired shapes of effective slit openings, which are useful for sorting live fish, can be produced. In the dimensioning, the slit openings can be adapted to the dimensions of the fish to be sorted. In a special embodiment of the invention, it is preferably and advantageously provided that the slit openings have a width of 180 mm and the vertical webs have a width of 60 mm so that the effective slit openings can be adjusted continuously between 180 mm and 60 mm. The height of the slit openings can preferably be 35 mm. With such dimensions, flatfish can be sorted particularly well in all growth stages.

In the sorting device described herein, the adjustment of the size of the effective slit openings is effected by a horizontal and/or vertical displacement of the adjustment plate on the carrier plate, wherein a purely horizontal displacement is preferred. A wide variety of design embodiments are conceivable. For example, various fixing holes can be provided, which are brought into overlap in different assignments and then blocked, for example, with plug pins. Rail systems in which the adjustment plate is guided on the carrier plate are also possible. However, it is particularly advantageous and preferred according to a next modification of the invention if the adjustment plate is guided laterally in a continuously displaceable manner between a receiving rail and a covering rail on the carrier plate and can be fixed by means of at least one locking device. With this design solution, the adjustment plate can be adjusted continuously for the fish in a particularly simple and stress-free manner. The adjustment plate is securely vertically mounted in the receiving rail on the carrier plate. The covering rail prevents the adjustment plate from folding away from the carrier plate. Both rails cover the contact gaps between the adjustment plate and the carrier plate and prevent the intermediate space from being contaminated in a possibly blocking manner and the fish from swimming into it. The effective slit openings can be adjusted in their width by simply laterally displacing the adjustment plate in the receiving rail, wherein the height of the effective slit openings remains constant and corresponds to the height of the slit openings. If the selected width of the effective slit openings is adjusted, it is fixed in a simple manner by actuating the locking device. The latter can consist, for example, of a threaded rod which runs in an elongated hole in the carrier plate and is tensioned against the carrier plate by means of two handles. A variation also in the height of the slit openings by vertically displacing the adjustment plate on the carrier plate is possible, for example, by means of a corresponding sliding-block guide in which a plurality of tensionable threaded rods is guided. In this case, the receiving and covering rails cover a larger region of the adjustment plate and allow it to move vertically.

Particularly important in a sorting device for live fish according to the invention is the extensive freedom of stress for the fish. Therefore, complicated assembly work in the water tank for fixing the carrier plate at a preselected location is avoided. This can preferably and advantageously take place in the invention in that the water tank is of rectangular design and has, on two parallel sides, running rails on which the carrier plate can be mounted in running carriages and can be positioned selectively along the water tank, wherein the carrier plate divides the water tank into the two regions via a flexible sealing apron as a circumferential sealing element. This design embodiment results in stable guidance and mounting of the carrier plate outside of the water tank. In addition, the flexible but stable sealing apron stably fixes the carrier plate and thus the entire grid unit in the interior of the water tank. The locking of the carrier plate at the provided location is likewise easily possible, for example by a bolt lock in perforated running rails. In order that the fish do not swim past the carrier plate, the sealing element is designed as a flexible sealing apron which nestles against the inside of the water tank. The stability of the mounting of the carrier plate can be improved even further if it is preferably and advantageously provided according to a next inventive modification that the carrier plate has on its upper side at the two ends two hook attachments which engage in two gap plates on the two running carriages. In particular, the hook attachments and the carrier plate can be formed integrally, for example from a fiber composite plate.

A particularly low stress load for the fish results during the sorting if the sorting occurs voluntarily. For this purpose, the grid unit in the invention is stationarily introduced into the water tank with a predetermined size of the slit openings. After a habituation time in slit openings “closed to the fish” (see above), the fish then swim through the exposed, effective slit openings voluntarily and in a playful, curious manner. Additional stimuli which can effectively support self-sorting are also shown below. When self-sorting is complete, the slit openings can be closed again so that the fish can continue to grow in the two different compartments. After a corresponding time, the effective slit openings can then be opened again or changed in their width so that the fish sort themselves again. With this separation into cohorts, which can be repeated as often as desired, it can be ensured that fish with a desired size can always be sorted or removed.

With somewhat more, but not yet deleterious, stress, active sorting can also be carried out in the invention. For this purpose, the grid unit is not left stationary in the water tank but is actively pulled through the water therein. In this case, the fish are forced together in the region toward which the grid unit is moved, so that finally, the fish with a suitable size up to the adjusted effective slit openings “escape” therethrough. For this active sorting process, it is advantageous and preferred if the carrier plate is arranged to be continuously displaceable on the running rails. For example, it can then be pulled manually (automation is readily possible) through the water tank until only those fish remain in front of the grid unit that do not fit through the adjusted effective slit openings. Thus, they are the largest fish in the water tank. They can then be easily removed from the water tank. The effective slit opening can then be reduced and the grid unit can be pushed manually (or also automatically) to the other end of the water tank. The fish that no longer fit through the effective slit openings are again separated. In this way, the entire fish population in the water tank can be sorted according to predetermined sizes by pulling the carrier plate back and forth several times with respectively different widths of the effective slit openings.

A similar effect of the different sorting by size can also be achieved in the voluntary, stress-minimized sorting of the fish if it is advantageously and preferably provided according to a next inventive modification that the grid unit has a plurality of carrier plates with adjustment plates respectively arranged thereon, which are arranged at a distance from one another in the water tank, wherein the effective slit openings are designed to be smaller (or larger as seen in the other direction) from carrier plate to carrier plate. The carrier plates are then arranged to be stationary again; the fish voluntarily swim through one or more carrier plates according to their size. The separation of the fish at the grid unit always results in a “sorting region” and a “non-sorting region.” In voluntary self-sorting, the region behind the grid unit can be regarded as a sorting region (all fish with a size equal to or smaller than the size of effective slit openings are present here, or they should be at the end of the sorting process). All fish that do not fit through the effective slit openings remain in the non-sorting region (all sizes larger than the size of the effective slit openings are located here). In the case of active sorting, the region in front of the grid unit can also be regarded as a non-sorting region because all other fish sort themselves through the effective slit openings. However, the region in front of the grid unit can also be referred to as a sorting region because at the end of the sorting process, only the fish from a size above the effective slit openings are still located here. All smaller ones have swum away through the effective slit openings. The designation is thus a matter of determination. In the invention, the (other) region into which the fish swim through the grid unit is to be referred to as a “sorting region.” The “non-sorting region” is correspondingly the (one) region in which the fish remain in front of the grid unit. A plurality of separate compartments is produced when a plurality of carriers and adjustment plates with differently sized effective slit openings are provided in the water tank. In this case, the sorting region in each case relative to the one carrier plate is also simultaneously the non-sorting region for the subsequent carrier plate.

In principle, the fish should swim voluntarily from the non-sorting region into the sorting region. For this purpose, it is advantageous to provide additional incentives to the fish, in particular also in order to largely prevent the fish from swimming from the sorting region back into the non-sorting region. Therefore, it can be advantageously and preferably provided in the invention that various stimuli for attracting the fish are additionally provided in the sorting region. In this case, it can preferably and advantageously be provided that the stimuli are formed by a food source, a light source, and/or a bright coloration. The fish are attracted by food, bright light, and bright colors occurring in the water. In contrast, they are repelled by darkness and dark colors. These findings are shown in detail in the above-mentioned publication by M. Bögner et al., which forms the closest prior art to the invention. Based on the obtained findings, it is also advantageous and preferred in the invention if the carrier plates and the adjustment plates have a bright coloration toward the one region (non-sorting region) and/or a dark coloration toward the other region (sorting region). The fish are thus attracted to the sorting region from the non-sorting region by the bright coloration, which is advantageously designed as occurring in the water, that is to say white, light blue, light yellow, or light green, on the front side of the carrier plate (and optionally the adjustment plate if it is located on the front side of the carrier plate), and prevented from swimming back into the non-sorting region by the dark coloration, advantageously designed as occurring in the water, that is to say black, dark blue, or dark green, on the rear side of the carrier plate (and optionally the adjustment plate if it is located on the rear side of the carrier plate).

Finally, in the case of the sorting device for live fish as described herein, further modifications can also be provided which are also provided in other sorting devices. In particular, it can preferably and advantageously be provided that a water inflow device and/or a camera device is arranged above the water tank. Fresh water can be continuously introduced into the water tank via the water inflow device, the camera device serves to monitor the fish in the water tank in order to be able to carry out general stock monitoring or detection of the biomass present but also to be able to detect in good time any increase in stress which may occur during voluntary or active sorting. Together with these modifications, the sorting device described herein is therefore particularly suitable for the aquaculture breeding of flatfish, in particular for voluntary self-sorting. Some types of flatfish are particularly well suited for aquaculture breeding and provide high yields of best quality. For this preferred application, further explanations can be taken from the publication by M. Bögner et al. In contrast, further explanations regarding the present invention and its mentioned modifications can be taken from the following exemplary embodiments.

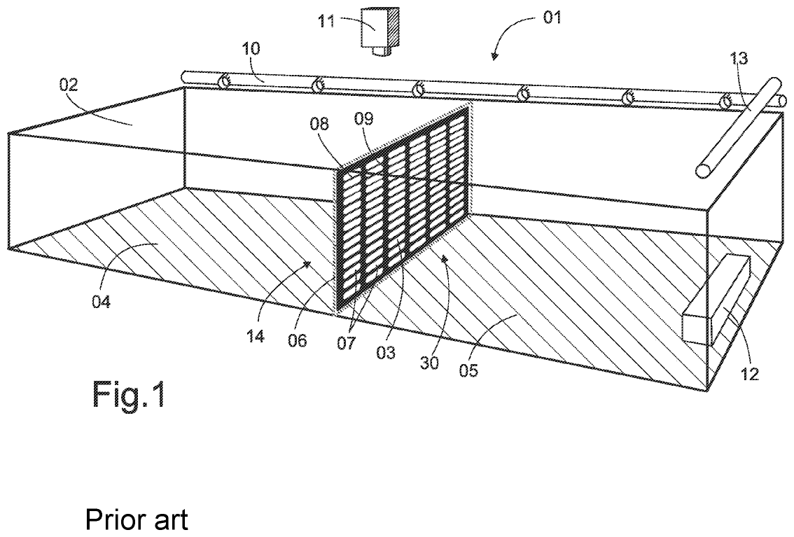

FIG. 1 shows the generic sorting device 01 for live fish (prior art) known from the aforementioned publication from M. Bögner et al. As main components are shown an upwardly open water tank 02 and a vertical grid unit 03, which divides the water tank 02 into a region 04 (“in front of” the grid unit 03, “non-sorting region”) and another region 05 (“behind” the grid unit 03, “sorting region”). A circumferential sealing element 06 on the grid unit 03 connects inside to the walls and the bottom of the water tank 02 and prevents the fish from laterally swimming past the stationary grid unit 03. The grid unit 03 shows a plurality of elongated hole-shaped, laterally rounded slit openings 07, delimited by horizontal webs 08 and vertical webs 09, wherein the horizontal webs 08 are thinner than the vertical webs 09. In this case, the shape and size of the slit openings 07 can be adapted to the fish to be sorted and can also be closed so that no fish can swim through. The closing of the grid unit 03 is useful during acclimatization and after termination of the sorting phase.

The sorting device 01 furthermore comprises a water inflow device 10, which ensures water conditions as uniform as possible in both regions 04, 05 (so that exclusively the additional stimuli used for attracting the fish are responsible), and a camera device 11, which serves the continuous observation of sorting success (both are not absolutely necessary in commercial installations or can also be implemented differently), above the water tank 02. In the other region 05 (sorting region), various stimuli for attracting the fish through the slit openings 07 are arranged in the grid unit 03. In the example shown, it is a food source 12 and a light source 13. As another stimulus, the grid unit 03 has in one region 04 (non-sorting region) a bright coloration 14 (e.g., the color white) to attract and in the other region 05 (sorting region) a dark coloration 30 (e.g., the color black) to repel the fish. Such attracting and repelling colorations can also be carried out on the inner sides of the water tank 02. As a rule, however, these are colored everywhere in the same hue, for example in a bright blue or green tone.

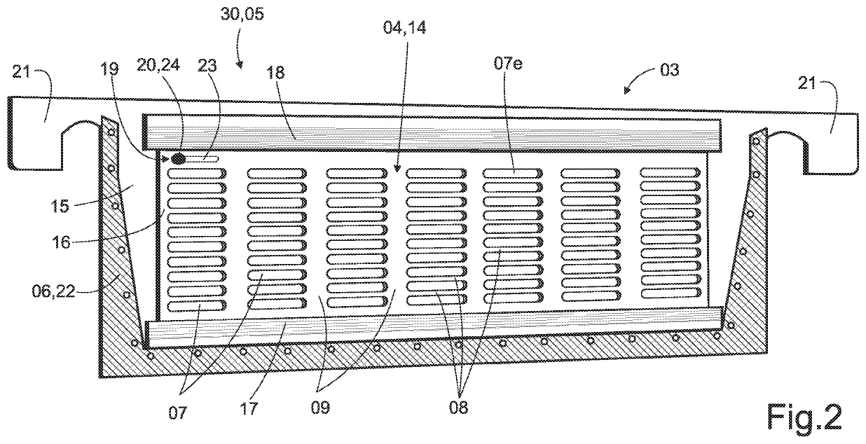

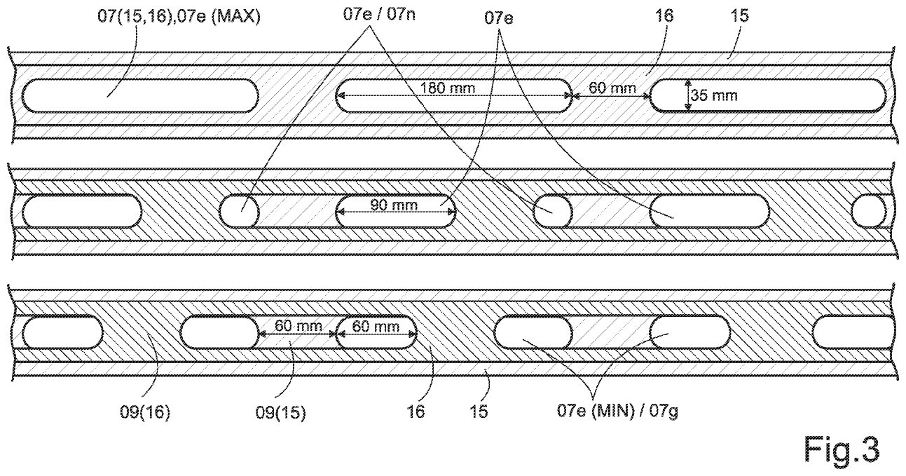

FIG. 2 shows in detail the grid unit 03. A carrier plate 15 and an adjustment plate 16 displaceably connected to the carrier plate 15 can be seen. In terms of their size and arrangement, both of these have identical slit openings 07 and thus also identical vertical and horizontal webs 08, 09. The slit openings 07 of carrier plate 15 and adjustment plate 16 are precisely placed on top of one another in the shown illustration so that a maximum value for the effective slit openings 07e results, see FIG. 3. The slit openings 07 have an elongated hole-like design and are arranged in parallel to the bottom of the water tank 02, cf. FIG. 1, in a plurality of rows and columns. The horizontal webs 08 between the slit openings 07 in a respective column are designed to be as narrow as structurally possible in order to provide the fish with a large cross-section to swim through. On the other hand, the vertical webs 09 between the columns are designed to be wider, for example five to six times as wide as the horizontal webs 08, because they cover the slit openings 07 in the carrier plate 15 in the case of a horizontal displacement of the adjustment plate 16. In the exemplary embodiment shown, all slit openings 07 have the same, constant height. The carrier plate 15 has a receiving rail 17 parallel to its lower edge, in which receiving rail the adjustment plate 16 is mounted. Parallel to its upper edge, the carrier plate 15 furthermore has a covering rail 18 which overlaps the adjustment plate 16. Both rails 17, 18 hold the adjustment plate 16 on the carrier plate 15 and cover the gap between the two so that dirt cannot settle and fish cannot swim into it. The lateral displaceability of the adjustment plate 16 is not impeded, however, and is limited only by the cross-sectional width of the water tank 02.

After the preselected positioning of the slit openings 07 of the adjustment plate 16 to the slit openings 07 of the carrier plate 15 and thus after establishing the current width of the effective slit openings 07e, the adjustment plate 16 is fixed to the carrier plate 15. This is done in the exemplary embodiment shown by actuating a locking device 19, wherein a threaded rod 20 engages through an elongated hole 23 in the carrier plate 15 and is tensioned by means of two handles 24 against the carrier plate 15. An arrangement of a plurality of such locking devices 18 along the upper edge of the adjustment plate 16 is easily possible but is not absolutely necessary since a single locking device 18 already works very well and is sufficient.

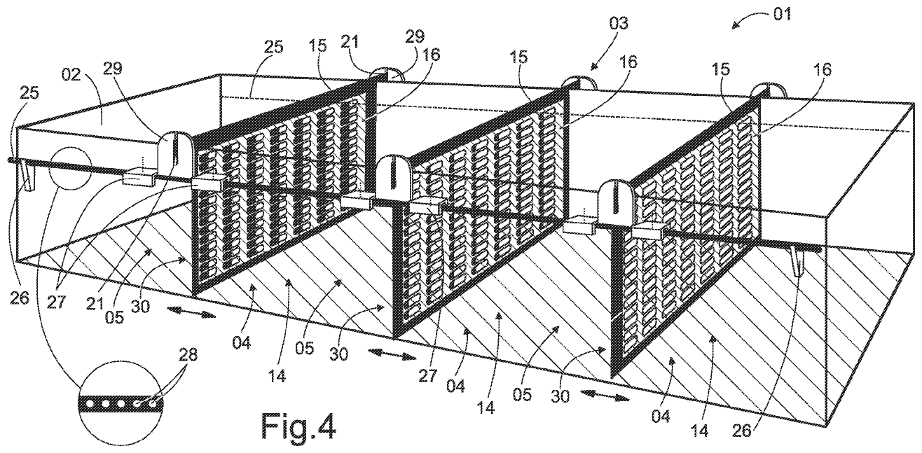

In addition, on the carrier plate 15 at the upper edge, hook attachments 21 are integrally formed, which serve the secure guidance of the grid unit 03 in the water tank 02, cf. FIG. 4. Lastly, FIG. 2 also shows the circumferential sealing element 06 in the form of a circumferential flexible sealing apron 22, which is screwed to the carrier plate 15 (with rust-proof plastic screws, as all other elements of the sorting device 01 described herein are also designed to be rust-proof) and nestles against the walls and the bottom of the water tank 02, cf. FIG. 1.

The illustrated grid unit 03 shows a bright coloration 14 and is thus oriented with the adjustment plate 16 toward the one region 04 (non-sorting region). On the other side, a dark coloration 30 toward the other region 05 (sorting region) is provided. A reverse arrangement is also readily possible, wherein the arrangement shown has the advantage that the “undisturbed” surface of the grid unit 03 faces the other region 05 (sorting region).

FIG. 3 shows a schematic representation of the adjustable widths of the effective slit openings 07e in a detail view of a row of slit openings 07 of the carrier plate 15 and the adjustment plate 16 in different adjustments. In the exemplary embodiment shown, the vertical webs 09 have a width of 60 mm, whereas the horizontal webs 08 (cf. FIG. 02) have a height of only 10 mm at most. Each slit opening 07 has a constant height of 35 mm and a width of 180 mm. In the fully opened state of the grid unit 03, the slit openings 07 of carrier plate 15 and adjustment plate 16 are congruent one above the other and the width of the slit openings 07 of the carrier plate 15 corresponds to the currently adjusted effective slit opening 07e (maximum value MAX, upper view in FIG. 3). By displacing the adjustment plate 16 laterally, a width of 60 mm can be adjusted minimally as the smallest effective slit opening 07e (minimum value MIN in the lower view of FIG. 3). With these dimensions, the effective slit openings 07e may be continuously adjusted between 180 mm and 60 mm. The adjustment MIN brings about the closing of the grid unit 03 for the fish to be sorted, wherein the water circulation is maintained. Moreover, non-sortable fish, which are smaller than the ones to be sorted, can freely swim through the water tank 02. The effective slit openings 07e are thus to be understood as slit openings 07g closed for the fish be sorted. In FIG. 3, the middle illustration shows an adjustment of the effective slit openings 07e between the limit values MAX and MIN. Smaller effective slit openings 07e can also be seen in this illustration, which however do not contribute to the sorting and can be referred to as ancillary slit openings 07n. It is furthermore indicated in FIG. 3 that the slit openings 07 are designed to be semi-circular at their two ends in order to produce a precisely defined slit width for the sorting process.

FIG. 4 shows the sorting device 01 with a rectangular water tank 02. On the parallel longitudinal sides of the water tank 02, two running rails 25 are arranged opposite one another and rest on attachments 26 on the outside of the water tank 02. One or more running carriages 27 run on each running rail 25. The running carriages 27 can be shifted along the running rails 25 and be fixed in a grid in bores 28 (see insert in FIG. 4). Two opposite running carriages 27 each on the water tank 02 have two gap plates 29, into which the carrier plate 15 of the grid unit 03 is mounted with the hook attachments 21. This results in a very stable mounting of the grid unit 03 without further fastening requirements within the water tank 02. With the aid of this mounting, active sorting can be easily carried out in the water tank 02, wherein the carrier plates 15 of the grid unit 03 are pulled through the water (indicated by double arrow).

FIG. 4 also shows a grid unit 03 with a plurality of carrier plates 15 and adjustment plates 16 (three pairs in the illustrated exemplary embodiment), which are arranged in parallel in the water tank 02 and divide it into a plurality of regions (non-sorting regions 04, sorting region 05). The width of the slit openings 07 is adjusted such that it becomes smaller from carrier plate 15 to carrier plate 15 (indicated in FIG. 04 from right to left). In this way, voluntary self-sorting of the fish in various size ranges can be achieved without additional stress. In order to further support the voluntary self-sorting of the fish, in addition to the stimuli provided in FIG. 1, it is also provided that the carrier plates 15 and the adjustment plates 16 have a bright coloration 14 toward the one region 04 (non-sorting region) and a dark coloration 30 toward the other region 05 (sorting region) (not visible in FIG. 4 since it is on the rear sides of the carrier plates 15).

The sorting device 01 for live fish, which is described herein, with its preferred modifications, is particularly suitable for subjecting flatfish to voluntary self-sorting or active sorting in aquaculture breeding without producing harmful stress.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

01 Sorting device
02 Water tank
03 Grid unit
04 One region (non-sorting region)
05 Other region (sorting region)
06 Sealing element
07 Slit opening in 15, 16
07e Effective slit opening
07g “Closed” effective slit opening
07n Ancillary effective slit opening
08 Horizontal web between 07
09 Vertical web between 07
10 Water inflow device
11 Camera device
12 Food source
13 Light source
14 Bright coloration
15 Carrier plate
16 Adjustment plate
17 Receiving rail
18 Covering rail
19 Locking device
20 Threaded rod
21 Hook attachment on 15
22 Sealing apron
23 Elongated hole
24 Handle
25 Running rail
26 Attachment on 02
27 Running carriages
28 Bore in 25
29 Gap plate
30 Dark coloration
MAX Maximum value for 07e
MIN Minimum value for 07e (=07g)

1. A sorting device for live fish, comprising:
an upwardly open water tank; and
a vertical grid unit connected to an inside of the water tank via a circumferential sealing element, dividing the water tank into two separate regions, the vertical grid unit having a plurality of slit openings which are delimited by horizontal and vertical webs and which are adaptable in shape and size to the fish to be sorted and are closeable,
wherein the grid unit comprises at least one carrier plate and at least one adjustment plate having an identical design and arrangement of the slit openings and of the horizontal and vertical webs,
wherein the at least one carrier plate divides the water tank into the two regions and the adjustment plate is displaceably arranged on the at least one carrier plate, and depending on a position of the adjustment plate, the slit openings of the at least one carrier plate are covered by the horizontal and vertical webs of the adjustment plate so as to form effective slit openings between a maximum value and a minimum value, and
wherein the effective slit openings on the at least one carrier plate are completely opened at the maximum value and are closed at the minimum value to such an extent that the fish to be sorted are prevented from swimming through.

2. The sorting device according to claim 1, wherein the slit openings in the at least one carrier plate and in the adjustment plate have an elongated hole-like design parallel to a bottom of the water tank and are arranged in a plurality of rows and columns, and
wherein all slit openings have a same height and width.

3. The sorting device according to claim 2, wherein the slit openings are semi-circular at their two ends.

4. The sorting device according to claim 2,
wherein the horizontal webs are as narrow as structurally possible and the vertical webs are wider than the horizontal webs.

5. The sorting device according to claim 2, wherein the slit openings have a width of 180 mm and the vertical webs have a width of 60 mm so that the effective slit openings are continuously adjustable between 180 mm and 60 mm.

6. The sorting device according to claim 2, wherein the adjustment plate is guided laterally continuously displaceably on the at least one carrier plate between a receiving rail and a covering rail and is fixed by at least one locking device.

7. The sorting device according to claim 1, wherein the water tank is of rectangular design and, on two parallel sides, has running rails on which the at least one carrier plate is mountable in running carriages and selectively positionable along the water tank, and
wherein the at least one carrier plate divides the water tank into the two regions via a flexible sealing apron as a circumferential sealing element.

8. The sorting device according to claim 7, wherein the at least one carrier plate has on an upper side thereof at the its two ends two hook attachments which engage in two gap plates on the two running carriages.

9. The sorting device according to claim 7,
wherein the at least one carrier plate is configured to be continuously displaceable on the running rails.

10. The sorting device according to claim 1,
wherein the at least one carrier plate comprises a plurality of carrier plates each having adjustment plates arranged thereon which are arranged at a distance from one another in the water tank, and
wherein the slit openings are smaller from carrier plate to carrier plate.

11. The sorting device according to claim 10,
wherein, in relation to the plurality of carrier plates, one region of the two regions comprises a non-sorting region and an other region of the two regions comprises a sorting region, and
wherein various stimuli for attracting the fish are provided in the sorting region.

12. The sorting device according to claim 11, wherein the stimuli comprise a food source, a light source, and/or a bright coloration.

13. The sorting device according to claim 11,
wherein the plurality of carrier plates and the adjustment plates have a bright coloration toward the non-sorting region and/or a dark coloration toward the sorting region.

14. The sorting device according to claim 1,
further comprising:
a water inflow device and/or a camera device arranged above the water tank.
